(19) United States
(12) Patent Application Publication
(10) Pub. No.: US 2023/0260239 A1
(43) Pub. Date: Aug. 17, 2023

(54) Turning a Two-Dimensional Image into a Skybox

(71) Applicant: Meta Platforms, Inc., Menlo Park, CA (US)

(72) Inventors: Vincent Charles CHEUNG, San Carlos, CA (US); Jiemin ZHANG, Sunnyvale, CA (US); Salvatore CANDIDO, San Francisco, CA (US); Hung-Yu TSENG, Bothell, WA (US)

(21) Appl. No.: 18/168,355

(22) Filed: Feb. 13, 2023

Related U.S. Application Data
(60) Provisional application No. 63/309,767, filed on Feb. 14, 2022.

(51) Int. Cl. G06T 19/20; G06V 20/20; G06T 7/70; G06T 3/00

(52) U.S. Cl. CPC G06T 19/20; G06V 20/20; G06T 7/70; G06T 3/0012; G06T 2200/24; G06T 2219/2021

(57) ABSTRACT

Aspects of the present disclosure are directed to creating a skybox for an artificial reality (“XR”) world from a two-dimensional (“2D”) image. The 2D image is scanned and split into at least two portions. The portions are mapped onto the interior of a virtual enclosed 3D shape, for example, a virtual cube. A generative adversarial network (GAN) interpolates from the information in the areas mapped from the portions to fill in at least some unmapped areas of the interior of the 3D shape. The 3D shape can be placed in a user's XR world to become the skybox surrounding that world.

### CROSS-REFERENCE TO RELATED APPLICATIONS

This application claims priority to U.S. Provisional Application No. 63/309,767, (Attorney Docket No. 3589-0120PV01) titled “A Two-Dimensional Image Into a Skybox,” filed Feb. 14, 2022, which is herein incorporated by reference in its entirety.

### BACKGROUND

Many people are turning to the promise of artificial reality (“XR”): XR worlds expand users' experiences beyond their real world, allow them to learn and play in new ways, and help them connect with other people. An XR world becomes familiar when its users customize it with particular environments and objects that interact in particular ways among themselves and with the users. As one aspect of this customization, users may choose a familiar environmental setting to anchor their world, a setting called the “skybox.” The skybox is the distant background, and it cannot be touched by the user, but in some implementations it may have changing weather, seasons, night and day, and the like. Creating even a static realistic skybox is beyond the abilities of many users.

### BRIEF DESCRIPTION OF THE DRAWINGS

FIG. 1A is a conceptual drawing of a 2D image to be converted into a skybox.

FIGS. 1B through 1F are conceptual drawings illustrating steps in a process according to the present technology for converting a 2D image into a skybox.

FIG. 1G is a conceptual drawing of a completed skybox.

FIG. 2 is a flow diagram illustrating a process used in some implementations of the present technology for converting a 2D image into a skybox.

FIG. 3 is a block diagram illustrating an overview of devices on which some implementations of the present technology can operate.

FIG. 4A is a wire diagram illustrating a virtual reality headset which can be used in some implementations of the present technology.

FIG. 4B is a wire diagram illustrating a mixed reality headset which can be used in some implementations of the present technology.

FIG. 4C is a wire diagram illustrating controllers which, in some implementations, a user can hold in one or both hands to interact with an artificial reality environment.

FIG. 5 is a block diagram illustrating an overview of an environment in which some implementations of the present technology can operate.

The techniques introduced here may be better understood by referring to the following Detailed Description in conjunction with the accompanying drawings, in which like reference numerals indicate identical or functionally similar elements.

### DETAILED DESCRIPTION

Aspects of the present disclosure are directed to techniques for building a skybox for an XR world from a user-selected 2D image. The 2D image is split into multiple portions. Each portion is mapped to an area on the interior of a virtual enclosed 3D shape. A generative adversarial network then interpolates from the information in areas mapped from the portions of the 2D image to fill in at least some of the unmapped areas of the interior of the 3D shape. When complete, the 3D shape becomes the skybox of the user's XR world.

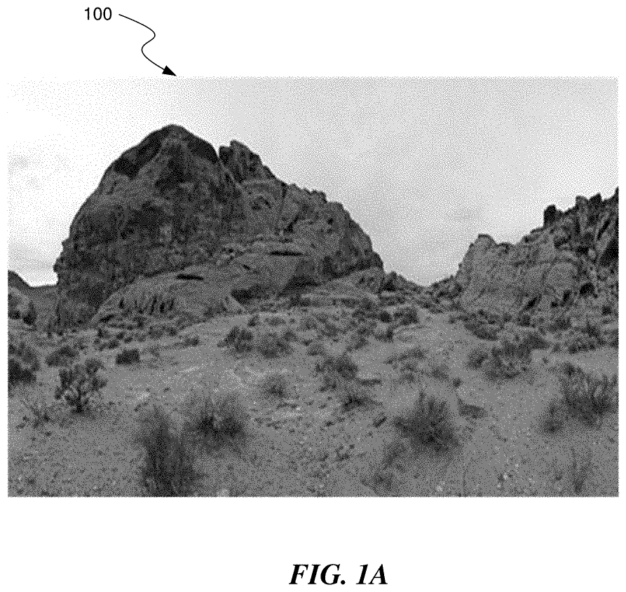

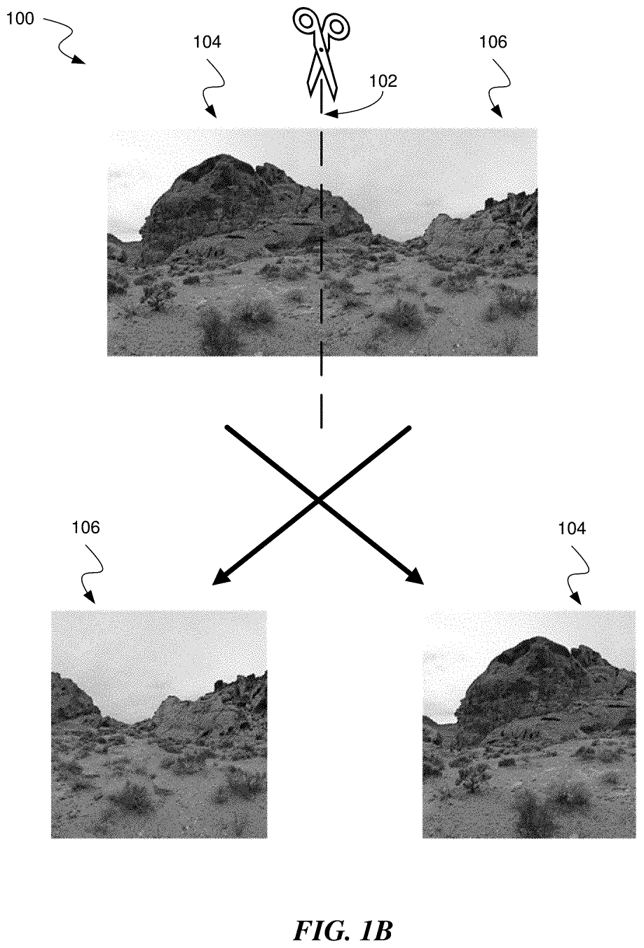

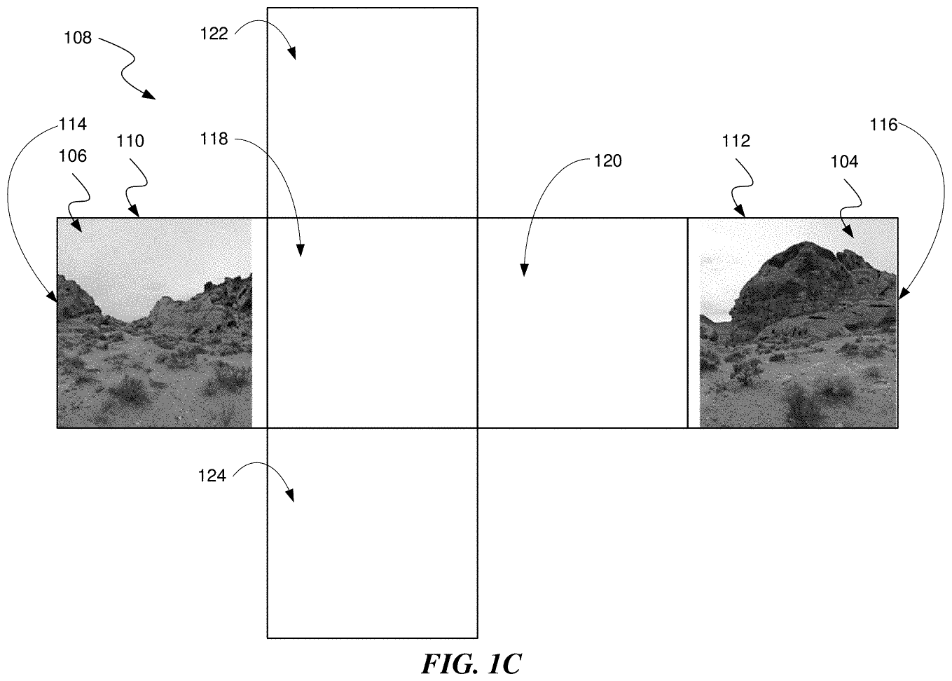

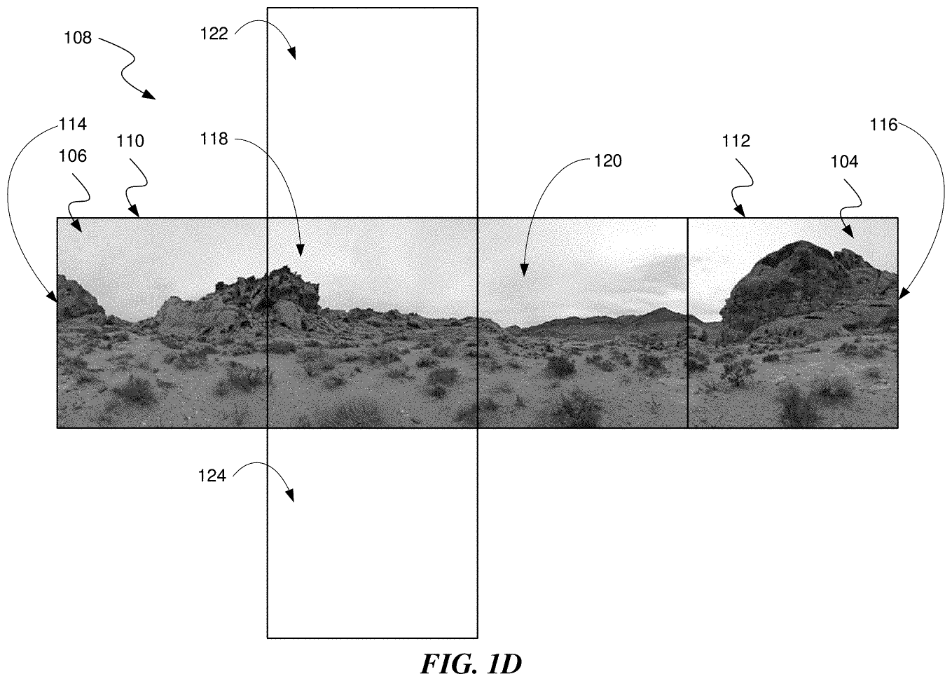

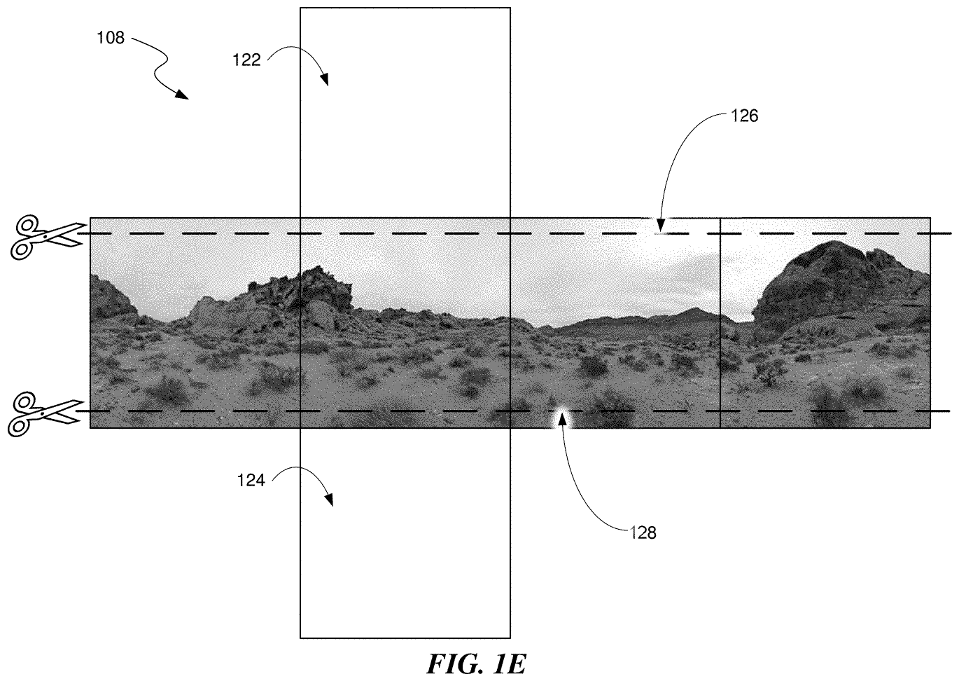

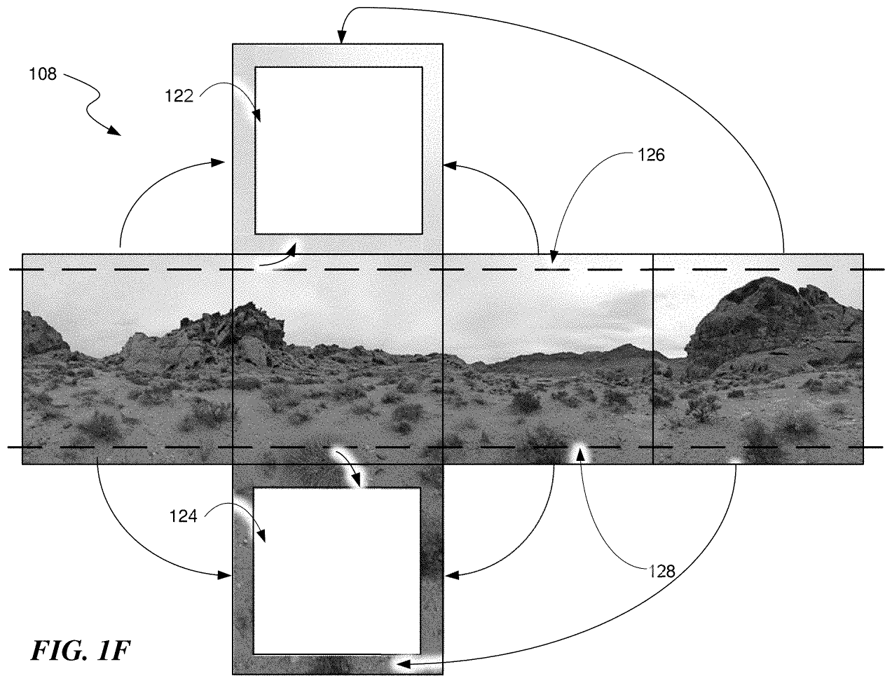

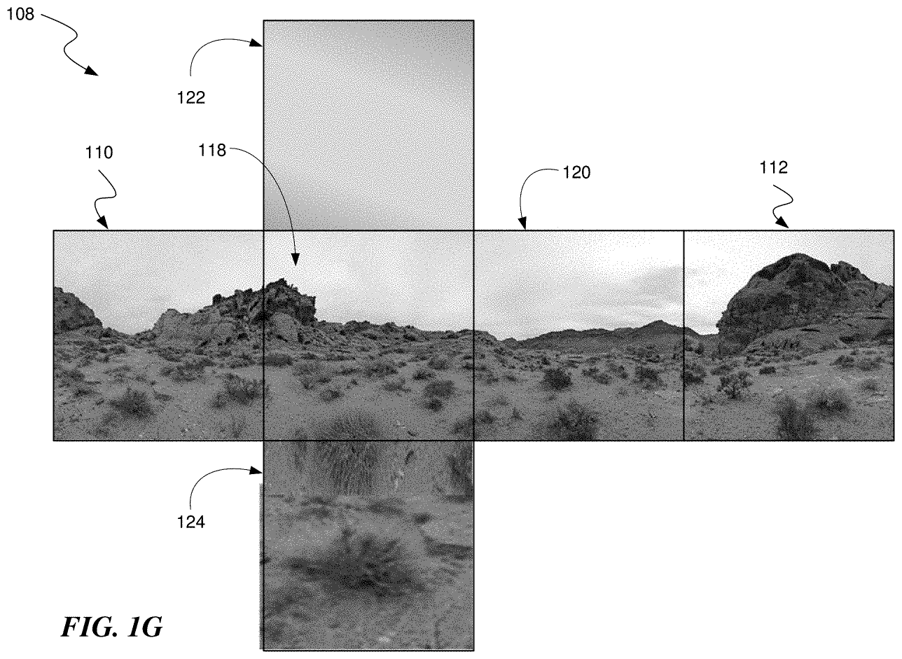

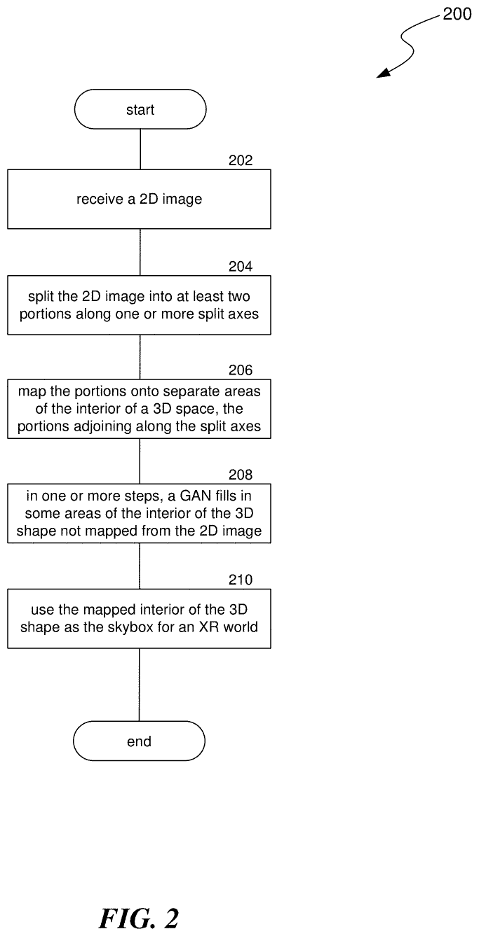

This process is illustrated in conjunction with FIGS. 1A through 1G and explained more thoroughly in the text accompanying FIG. 2. The example of the Figures assumes that the 2D image is mapped onto the interior of a 3D cube. In some implementations, other geometries such as a sphere, half sphere, etc. can be used.

FIG. 1A shows a 2D image 100 selected by a user to use as the skybox backdrop. While the user's choice is free, in general this image 100 is a landscape seen from afar with an open sky above. The user can choose an image 100 to impart a sense of familiarity or of exoticism to his XR world.

The top of FIG. 1B illustrates the first step of the skybox-building process. The image 100 is split into multiple portions along split line 102. Here, the split creates a left portion 104 and a right portion 106. While FIG. 1B shows an even split into exactly two portions 104 and 106, that is not required. The bottom of FIG. 1B shows the potions 104 and 106 logically swapped left to right.

In FIG. 1C, the portions 104 and 106 are mapped onto interior faces of a virtual cube 108. The cube 108 is shown as unfolded, which can allow a GAN, trained to fill in the portions for a flat image, to fill in portions of the cube. The portion 106 from the right side of the 2D image 100 is mapped onto cube face 110 on the left of FIG. 1C, and the portion 104 from the left side of the 2D image 100 is mapped onto the cube face 112 on the right of FIG. 1C. Note that the mapping of the portions 104 and 106 onto the cube faces 112 and 110 need not entirely fill in those faces 112 and 110. Note also that when considering the cube 108 folded up with the mappings inside of it, the outer edge 114 of cube face 110 lines up with the outer edge 116 of cube face 112. These two edges 114 and 116 represent the edges of the portions 106 and 104 along the split line 102 illustrated in FIG. 1 B. Thus, the mapping shown in FIG. 1C preserves the continuity of the 2D image 100 along the split line 102.

In FIG. 1D, a generative adversarial network “fills in” the area between the two portions 106 and 104. In FIG. 1D, the content generated by the generative adversarial network has filled in the rightmost part of cube face 110 (which was not mapped in the example of FIG. 1C), the leftmost part of cube face 112 (similarly not mapped), and the entirety of cube faces 118 and 120. By using artificial-intelligence techniques, the generative adversarial network produces realistic interpolations here based on the aspects shown in the image portions 106 and 104.

In some implementations, the work of the generative adversarial network is done when the interpolation of FIG. 1D is accomplished. In other cases, the work proceeds to FIGS. 1E through 1G.

In FIG. 1E, the system logically “trims” the work so far produced along a top line 126 and a bottom line 128. The arrows of FIG. 1F show how the generative adversarial network maps the trimmed portions to the top 122 and bottom 124 cube faces. In the illustrated case, the top trimmed portions include only sky, and the bottom trimmed portions include only small landscape details but no large masses.

From the trimmed portions added in FIG. 1F, the generative adversarial network in FIG. 1G again applies artificial-intelligence techniques to interpolate and thus to fill in the remaining portions of top 122 and bottom 124 cube faces.

The completed cube 108 is shown in FIG. 1G with the mapped areas on the cube 108′s interior. It is ready to become a skybox in the user's XR world. The four cube faces 110, 118, 120, and 112 become the far distant horizon view of the world. The top cube face 122 is the user's sky, and the bottom cube face 124 (if used, see the discussion below) becomes the ground below him. When placed in the user's XR world, the edges of the skybox cube 108 are not visible to the user and do not distort the view.

FIG. 2 is a flow diagram illustrating a process 200 used in some implementations for building a skybox from a 2D image. In some variations, process 200 begins when a user executes an application for the creation of skyboxes. In some implementations, this can be from within an artificial reality environment where the user can initiate process 200 by interacting with one or more virtual objects. The user's interaction can include looking at, pointing at, or touching the skybox-creation virtual object (control element). In some variations, process 200 can begin when the user verbally expresses a command to create a skybox, and that expression is mapped into a semantic space (e.g., by applying an NLP model) to determine the user's intent from the words of the command.

At block 202, process 200 receives a 2D image, such as the image 100 in FIG. 1A. The image may (but is not required to) include an uncluttered sky that can later be manipulated by an application to show weather, day and night, and the like.

At block 204, process 200 splits the received image 100 into at least two portions. FIG. 1B shows the split as a vertical line 102, but that need not be the case. The split also need not produce equal-size portions. However, for a two-way split, the split should leave the entirety of one side of the image in one portion and the entirety of the other side in the other portion. The split line 102 of FIG. 1B acceptably splits the 2D image 100.

At block 206, process 200 creates a panoramic image from the split image. This can include swapping the positions of the image along the split line, spreading them apart and having a GAN fill in the area between them. In some cases, this can include mapping the portions resulting from the split onto separate areas on the interior of a 3D space. For the example if the 3D space is a virtual cube 108, the mappings need not completely fill the interior faces of the cube 108. In any case, the portions are mapped so that the edges of the portions at the split line(s) 102 match up with one another. For the example of FIGS. 1A through 1G, FIG. 1C shows the interior of the cube 108 with portion 104 mapped onto most of cube face 112 and portion 106 mapped onto most of cube face 110. Considering the cube 108 as folded up with the mapped images on the interior, the left edge 114 of cube face 110 matches up with the right edge 116 of cube face 112. That is, the original 2D image is once again complete but spread over the two cube faces 110 and 112. In more complicated mappings of more than two portions or of a non-cubical 3D shape, the above principle of preserving image integrity along the split lines still applies.

At block 208, process 200 invokes a generative adversarial network to interpolate and fill in areas of the interior of the 3D shape not already mapped from the portions of the 2D image. This may be done in steps with the generative adversarial network mapping always interpolating into the space between two or more known edges. In the cube 108 example of FIG. 1C, the generative adversarial network as a first step applies artificial-intelligence techniques to map the space between the right edge of the portion 106 and the left edge of the portion 104. An example of the result of this interpolated mapping is shown in FIG. 1D.

Process 200 can then take a next step by interpolating from the edges of the already mapped areas into any unmapped areas. This process may continue through several steps with the generative adversarial network always interpolating between known information to produce realistic results. Following the example result of FIG. 1D, process 200 can interpolating from the edges of the already mapped areas. In FIG. 1F, this means moving the mapped areas above the upper logical trim line 126 to create known border areas for the top interior face 122 of the 3D cube 108, and moving the mapped areas below the lower logical trim line 128 to create known border areas for the bottom interior cube face 124. The generative adversarial network can then be applied to fill in these areas. The result in this is the complete skybox, as is shown in FIG. 1G.

The step by step interpolative process of the generative adversarial network described above need not always continue until the entire of the interior of the 3D shape is filled in. For example, if the XR world includes an application that creates sky effects for the skybox, then the sky need not be filled in by the generative adversarial network but could be left to that application. In some cases, the ground beneath the user need not be filled in as the user's XR world may has its own ground.

At block 210, the mapped interior of the 3D shape is used as a skybox in the user's XR world.

Embodiments of the disclosed technology may include or be implemented in conjunction with an artificial reality system. Artificial reality or extra reality (XR) is a form of reality that has been adjusted in some manner before presentation to a user, which may include, e.g., virtual reality (VR), augmented reality (AR), mixed reality (MR), hybrid reality, or some combination and/or derivatives thereof. Artificial reality content may include completely generated content or generated content combined with captured content (e.g., real-world photographs). The artificial reality content may include video, audio, haptic feedback, or some combination thereof, any of which may be presented in a single channel or in multiple channels (such as stereo video that produces a three-dimensional effect to the viewer). Additionally, in some embodiments, artificial reality may be associated with applications, products, accessories, services, or some combination thereof, that are, e.g., used to create content in an artificial reality and/or used in (e.g., perform activities in) an artificial reality. The artificial reality system that provides the artificial reality content may be implemented on various platforms, including a head-mounted display (HMD) connected to a host computer system, a standalone HMD, a mobile device or computing system, a “cave” environment or other projection system, or any other hardware platform capable of providing artificial reality content to one or more viewers.

“Virtual reality” or “VR,” as used herein, refers to an immersive experience where a user's visual input is controlled by a computing system. “Augmented reality” or “AR” refers to systems where a user views images of the real world after they have passed through a computing system. For example, a tablet with a camera on the back can capture images of the real world and then display the images on the screen on the opposite side of the tablet from the camera. The tablet can process and adjust or “augment” the images as they pass through the system, such as by adding virtual objects. “Mixed reality” or “MR” refers to systems where light entering a user's eye is partially generated by a computing system and partially composes light reflected off objects in the real world. For example, a MR headset could be shaped as a pair of glasses with a pass-through display, which allows light from the real world to pass through a waveguide that simultaneously emits light from a projector in the MR headset, allowing the MR headset to present virtual objects intermixed with the real objects the user can see. “Artificial reality,” “extra reality,” or “XR,” as used herein, refers to any of VR, AR, MR, or any combination or hybrid thereof.

Previous systems do not support non-tech-savvy users in creating a skybox for their XR world. Instead, many users left the skybox blank or choose one ready made. Lacking customizability, these off-the-shelf skyboxes made the user's XR world look foreign and thus tended to disengage users from their own XR world. The skybox creation systems and methods disclosed herein are expected to overcome these deficiencies in existing systems. Through the simplicity of its interface (the user only has to provide a 2D image), the skybox creator helps even unsophisticated users to add a touch of familiarity or of exoticness, as they choose, to their world. There is no analog among previous technologies for this ease of user-directed world customization. By supporting every user's creativity, the skybox creator eases the entry of all users into the XR worlds, thus increasing the participation of people in the benefits provided by XR, and, in consequence, enhancing the value of the XR worlds and the systems that support them.

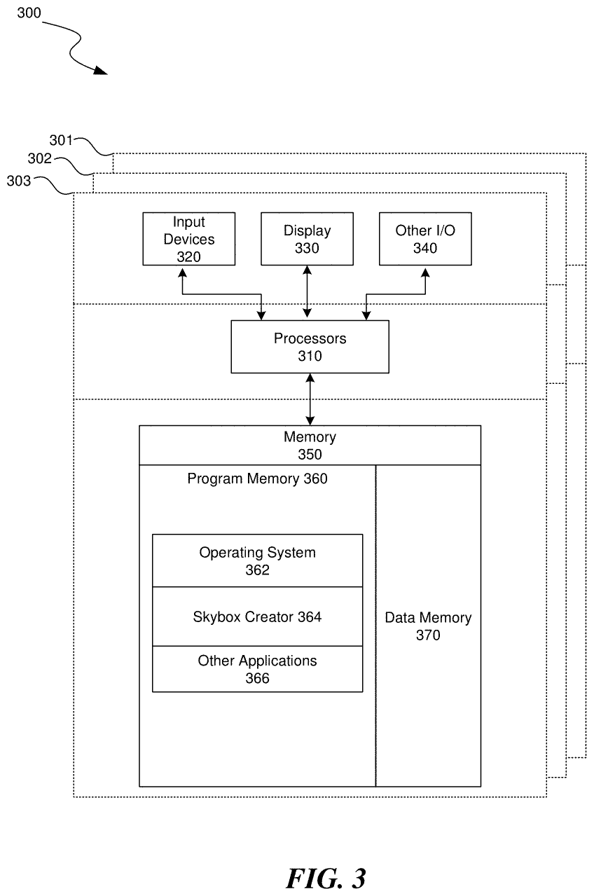

Several implementations are discussed below in more detail in reference to the figures. FIG. 3 is a block diagram illustrating an overview of devices on which some implementations of the disclosed technology can operate. The devices can comprise hardware components of a computing system 300 that converts a 2D image into a skybox. In various implementations, computing system 300 can include a single computing device 303 or multiple computing devices (e.g., computing device 301, computing device 302, and computing device 303) that communicate over wired or wireless channels to distribute processing and share input data. In some implementations, computing system 300 can include a stand-alone headset capable of providing a computer created or augmented experience for a user without the need for external processing or sensors. In other implementations, computing system 300 can include multiple computing devices such as a headset and a core processing component (such as a console, mobile device, or server system) where some processing operations are performed on the headset and others are offloaded to the core processing component. Example headsets are described below in relation to FIGS. 2A and 2B. In some implementations, position and environment data can be gathered only by sensors incorporated in the headset device, while in other implementations one or more of the non-headset computing devices can include sensor components that can track environment or position data.

Computing system 300 can include one or more processor(s) 310 (e.g., central processing units (CPUs), graphical processing units (GPUs), holographic processing units (HPUs), etc.) Processors 310 can be a single processing unit or multiple processing units in a device or distributed across multiple devices (e.g., distributed across two or more of computing devices 301-303).

Computing system 300 can include one or more input devices 320 that provide input to the processors 310, notifying them of actions. The actions can be mediated by a hardware controller that interprets the signals received from the input device and communicates the information to the processors 310 using a communication protocol. Each input device 320 can include, for example, a mouse, a keyboard, a touchscreen, a touchpad, a wearable input device (e.g., a haptics glove, a bracelet, a ring, an earring, a necklace, a watch, etc.), a camera (or other light-based input device, e.g., an infrared sensor), a microphone, or other user input devices.

Processors 310 can be coupled to other hardware devices, for example, with the use of an internal or external bus, such as a PCI bus, SCSI bus, or wireless connection. The processors 310 can communicate with a hardware controller for devices, such as for a display 330. Display 330 can be used to display text and graphics. In some implementations, display 330 includes the input device as part of the display, such as when the input device is a touchscreen or is equipped with an eye direction monitoring system. In some implementations, the display is separate from the input device. Examples of display devices are: an LCD display screen, an LED display screen, a projected, holographic, or augmented reality display (such as a heads-up display device or a head-mounted device), and so on. Other I/O devices 340 can also be coupled to the processor, such as a network chip or card, video chip or card, audio chip or card, USB, firewire or other external device, camera, printer, speakers, CD-ROM drive, DVD drive, disk drive, etc.

In some implementations, input from the I/O devices 340, such as cameras, depth sensors, IMU sensor, GPS units, LiDAR or other time-of-flights sensors, etc. can be used by the computing system 300 to identify and map the physical environment of the user while tracking the user's location within that environment. This simultaneous localization and mapping (SLAM) system can generate maps (e.g., topologies, girds, etc.) for an area (which may be a room, building, outdoor space, etc.) and/or obtain maps previously generated by computing system 300 or another computing system that had mapped the area. The SLAM system can track the user within the area based on factors such as GPS data, matching identified objects and structures to mapped objects and structures, monitoring acceleration and other position changes, etc.

Computing system 300 can include a communication device capable of communicating wirelessly or wire-based with other local computing devices or a network node. The communication device can communicate with another device or a server through a network using, for example, TCP/IP protocols. Computing system 300 can utilize the communication device to distribute operations across multiple network devices.

The processors 310 can have access to a memory 350, which can be contained on one of the computing devices of computing system 300 or can be distributed across of the multiple computing devices of computing system 300 or other external devices. A memory includes one or more hardware devices for volatile or non-volatile storage, and can include both read-only and writable memory. For example, a memory can include one or more of random access memory (RAM), various caches, CPU registers, read-only memory (ROM), and writable non-volatile memory, such as flash memory, hard drives, floppy disks, CDs, DVDs, magnetic storage devices, tape drives, and so forth. A memory is not a propagating signal divorced from underlying hardware; a memory is thus non-transitory. Memory 350 can include program memory 360 that stores programs and software, such as an operating system 362, a Skybox creator 364 that works from a 2D image, and other application programs 366. Memory 350 can also include data memory 370 that can include, e.g., parameters for running an image-converting generative adversarial network, configuration data, settings, user options or preferences, etc., which can be provided to the program memory 360 or any element of the computing system 300.

Some implementations can be operational with numerous other computing system environments or configurations. Examples of computing systems, environments, and/or configurations that may be suitable for use with the technology include, but are not limited to, XR headsets, personal computers, server computers, handheld or laptop devices, cellular telephones, wearable electronics, gaming consoles, tablet devices, multiprocessor systems, microprocessor-based systems, set-top boxes, programmable consumer electronics, network PCs, minicomputers, mainframe computers, distributed computing environments that include any of the above systems or devices, or the like.

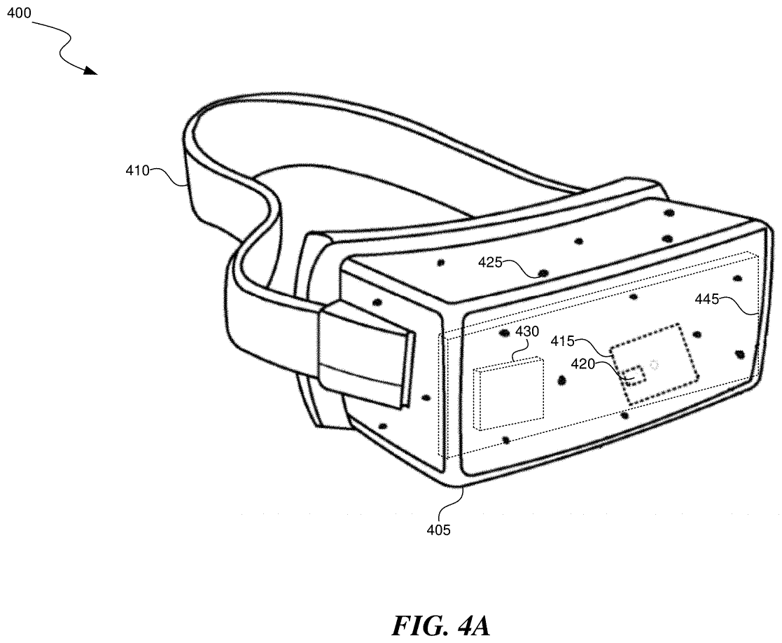

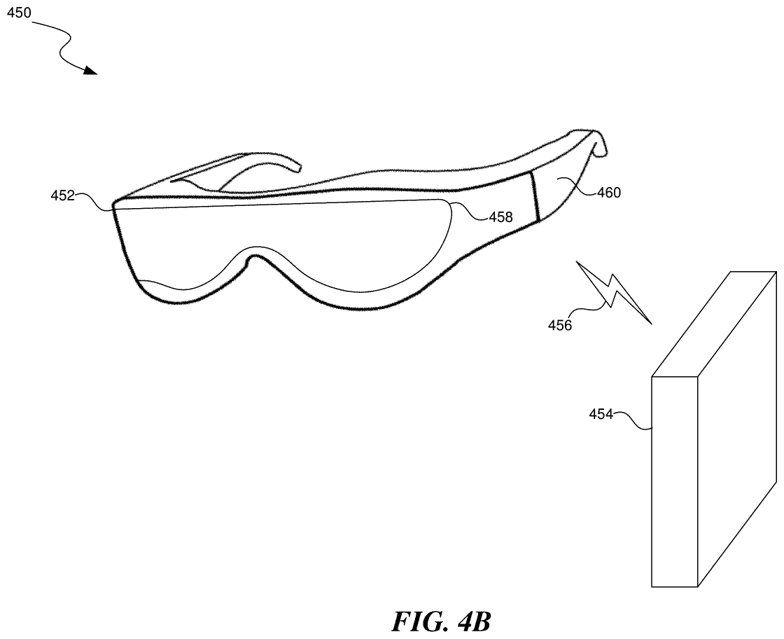

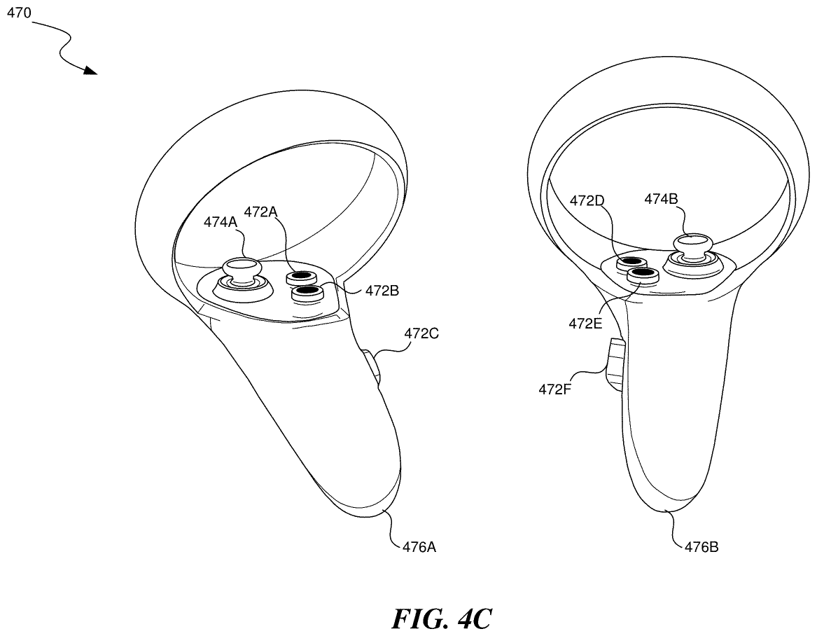

FIG. 4A is a wire diagram of a virtual reality head-mounted display (HMD) 400, in accordance with some embodiments. The HMD 400 includes a front rigid body 405 and a band 410. The front rigid body 405 includes one or more electronic display elements of an electronic display 445, an inertial motion unit (IMU) 415, one or more position sensors 420, locators 425, and one or more compute units 430. The position sensors 420, the IMU 415, and compute units 430 may be internal to the HMD 400 and may not be visible to the user. In various implementations, the IMU 415, position sensors 420, and locators 425 can track movement and location of the HMD 400 in the real world and in an artificial reality environment in three degrees of freedom (3DoF) or six degrees of freedom (6DoF). For example, the locators 425 can emit infrared light beams which create light points on real objects around the HMD 400. As another example, the IMU 415 can include e.g., one or more accelerometers, gyroscopes, magnetometers, other non-camera-based position, force, or orientation sensors, or combinations thereof. One or more cameras (not shown) integrated with the HMD 400 can detect the light points. Compute units 430 in the HMD 400 can use the detected light points to extrapolate position and movement of the HMD 400 as well as to identify the shape and position of the real objects surrounding the HMD 400.

The electronic display 445 can be integrated with the front rigid body 405 and can provide image light to a user as dictated by the compute units 430. In various embodiments, the electronic display 445 can be a single electronic display or multiple electronic displays (e.g., a display for each user eye). Examples of the electronic display 445 include: a liquid crystal display (LCD), an organic light-emitting diode (OLED) display, an active-matrix organic light-emitting diode display (AMOLED), a display including one or more quantum dot light-emitting diode (QOLED) sub-pixels, a projector unit (e.g., microLED, LASER, etc.), some other display, or some combination thereof.

In some implementations, the HMD 400 can be coupled to a core processing component such as a personal computer (PC) (not shown) and/or one or more external sensors (not shown). The external sensors can monitor the HMD 400 (e.g., via light emitted from the HMD 400) which the PC can use, in combination with output from the IMU 415 and position sensors 420, to determine the location and movement of the HMD 400.

FIG. 4B is a wire diagram of a mixed reality HMD system 450 which includes a mixed reality HMD 452 and a core processing component 454. The mixed reality HMD 452 and the core processing component 454 can communicate via a wireless connection (e.g., a 60 GHz link) as indicated by link 456. In other implementations, the mixed reality system 450 includes a headset only, without an external compute device or includes other wired or wireless connections between the mixed reality HMD 452 and the core processing component 454. The mixed reality HMD 452 includes a pass-through display 458 and a frame 460. The frame 460 can house various electronic components (not shown) such as light projectors (e.g., LASERs, LEDs, etc.), cameras, eye-tracking sensors, MEMS components, networking components, etc.

The projectors can be coupled to the pass-through display 458, e.g., via optical elements, to display media to a user. The optical elements can include one or more waveguide assemblies, reflectors, lenses, mirrors, collimators, gratings, etc., for directing light from the projectors to a user's eye. Image data can be transmitted from the core processing component 454 via link 456 to HMD 452. Controllers in the HMD 452 can convert the image data into light pulses from the projectors, which can be transmitted via the optical elements as output light to the user's eye. The output light can mix with light that passes through the display 458, allowing the output light to present virtual objects that appear as if they exist in the real world.

Similarly to the HMD 400, the HMD system 450 can also include motion and position tracking units, cameras, light sources, etc., which allow the HMD system 450 to, e.g., track itself in 3DoF or 6DoF, track portions of the user (e.g., hands, feet, head, or other body parts), map virtual objects to appear as stationary as the HMD 452 moves, and have virtual objects react to gestures and other real-world objects.

FIG. 4C illustrates controllers 470 (including controller 476A and 476B), which, in some implementations, a user can hold in one or both hands to interact with an artificial reality environment presented by the HMD 400 and/or HMD 450. The controllers 470 can be in communication with the HMDs, either directly or via an external device (e.g., core processing component 454). The controllers can have their own IMU units, position sensors, and/or can emit further light points. The HMD 400 or 450, external sensors, or sensors in the controllers can track these controller light points to determine the controller positions and/or orientations (e.g., to track the controllers in 3DoF or 6DoF). The compute units 430 in the HMD 400 or the core processing component 454 can use this tracking, in combination with IMU and position output, to monitor hand positions and motions of the user. The controllers can also include various buttons (e.g., buttons 472A-F) and/or joysticks (e.g., joysticks 474A-B), which a user can actuate to provide input and interact with objects.

In various implementations, the HMD 400 or 450 can also include additional subsystems, such as an eye tracking unit, an audio system, various network components, etc., to monitor indications of user interactions and intentions. For example, in some implementations, instead of or in addition to controllers, one or more cameras included in the HMD 400 or 450, or from external cameras, can monitor the positions and poses of the user's hands to determine gestures and other hand and body motions. As another example, one or more light sources can illuminate either or both of the user's eyes and the HMD 400 or 450 can use eye-facing cameras to capture a reflection of this light to determine eye position (e.g., based on set of reflections around the user's cornea), modeling the user's eye and determining a gaze direction.

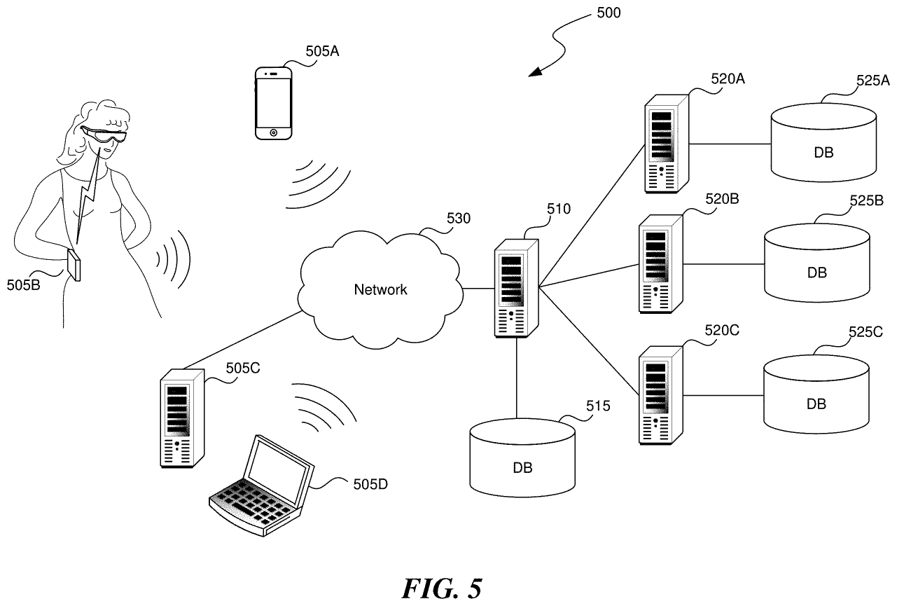

FIG. 5 is a block diagram illustrating an overview of an environment 500 in which some implementations of the disclosed technology can operate. Environment 500 can include one or more client computing devices 505A-D, examples of which can include computing system 100. In some implementations, some of the client computing devices (e.g., client computing device 505B) can be the HMD 400 or the HMD system 450. Client computing devices 505 can operate in a networked environment using logical connections through network 530 to one or more remote computers, such as a server computing device.

In some implementations, server 510 can be an edge server which receives client requests and coordinates fulfillment of those requests through other servers, such as servers 520A-C. Server computing devices 510 and 520 can comprise computing systems, such as computing system 100. Though each server computing device 510 and 520 is displayed logically as a single server, server computing devices can each be a distributed computing environment encompassing multiple computing devices located at the same or at geographically disparate physical locations.

Client computing devices 505 and server computing devices 510 and 520 can each act as a server or client to other server/client device(s). Server 510 can connect to a database 515. Servers 520A-C can each connect to a corresponding database 525A-C. As discussed above, each server 510 or 520 can correspond to a group of servers, and each of these servers can share a database or can have their own database. Though databases 515 and 525 are displayed logically as single units, databases 515 and 525 can each be a distributed computing environment encompassing multiple computing devices, can be located within their corresponding server, or can be located at the same or at geographically disparate physical locations.

Network 530 can be a local area network (LAN), a wide area network (WAN), a mesh network, a hybrid network, or other wired or wireless networks. Network 530 may be the Internet or some other public or private network. Client computing devices 505 can be connected to network 530 through a network interface, such as by wired or wireless communication. While the connections between server 510 and servers 520 are shown as separate connections, these connections can be any kind of local, wide area, wired, or wireless network, including network 530 or a separate public or private network.

Those skilled in the art will appreciate that the components illustrated in FIGS. 3 through 5 described above, and in each of the flow diagrams, may be altered in a variety of ways. For example, the order of the logic may be rearranged, substeps may be performed in parallel, illustrated logic may be omitted, other logic may be included, etc. In some implementations, one or more of the components described above can execute one or more of the processes also described above.

Reference in this specification to “implementations” (e.g., “some implementations,” “various implementations,” “one implementation,” “an implementation,” etc.) means that a particular feature, structure, or characteristic described in connection with the implementation is included in at least one implementation of the disclosure. The appearances of these phrases in various places in the specification are not necessarily all referring to the same implementation, nor are separate or alternative implementations mutually exclusive of other implementations. Moreover, various features are described which may be exhibited by some implementations and not by others. Similarly, various requirements are described which may be requirements for some implementations but not for other implementations.

As used herein, being above a threshold means that a value for an item under comparison is above a specified other value, that an item under comparison is among a certain specified number of items with the largest value, or that an item under comparison has a value within a specified top percentage value. As used herein, being below a threshold means that a value for an item under comparison is below a specified other value, that an item under comparison is among a certain specified number of items with the smallest value, or that an item under comparison has a value within a specified bottom percentage value. As used herein, being within a threshold means that a value for an item under comparison is between two specified other values, that an item under comparison is among a middle-specified number of items, or that an item under comparison has a value within a middle-specified percentage range. Relative terms, such as high or unimportant, when not otherwise defined, can be understood as assigning a value and determining how that value compares to an established threshold. For example, the phrase “selecting a fast connection” can be understood to mean selecting a connection that has a value assigned corresponding to its connection speed that is above a threshold.

As used herein, the word “or” refers to any possible permutation of a set of items. For example, the phrase “A, B, or C” refers to at least one of A, B, C, or any combination thereof, such as any of: A; B; C; A and B; A and C; B and C; A, B, and C; or multiple of any item such as A and A; B, B, and C; A, A, B, C, and C; etc.

Although the subject matter has been described in language specific to structural features and/or methodological acts, it is to be understood that the subject matter defined in the appended claims is not necessarily limited to the specific features or acts described above. Specific embodiments and implementations have been described herein for purposes of illustration, but various modifications can be made without deviating from the scope of the embodiments and implementations. The specific features and acts described above are disclosed as example forms of implementing the claims that follow. Accordingly, the embodiments and implementations are not limited except as by the appended claims.

Any patents, patent applications, and other references noted above are incorporated herein by reference. Aspects can be modified, if necessary, to employ the systems, functions, and concepts of the various references described above to provide yet further implementations. If statements or subject matter in a document incorporated by reference conflicts with statements or subject matter of this application, then this application shall control.

1-3 (canceled).

4. A method for managing multiple virtual containers in an artificial reality environment, the method comprising:
receiving an identification of a surface in the artificial reality environment with at least a surface type property;
identifying at least one virtual container, of the multiple virtual containers, that is associated with the identified surface; and
providing one or more properties of the identified surface to the identified at least one virtual container;
wherein the identified at least one virtual container selects a current display mode based at least in part on the one or more properties of the identified surface, and
wherein the current display mode A) controls how the identified at least one virtual container writes content into a defined size or shape of an area or a volume that was set for the identified at least one virtual container in the current display mode and B) corresponds to the surface type property of the identified surface.

5. The method of claim 4,
wherein the surface type property of the identified surface specifies a spatial orientation of the identified surface; and
wherein the identified at least one virtual container evaluates one or more conditions to select the current display mode that corresponds to the spatial orientation of the identified surface.

6. The method of claim 4, wherein the surface type property of the identified surface specifies an orientation of the identified surface or a type of object the identified surface is attached to.

7. The method of claim 4, wherein the surface type property of the identified surface specifies types of virtual containers that can be added to the identified surface.

8. The method of claim 4, wherein the one or more properties of the identified surface further include tags identified by machine learning models trained to specify tags for particular surfaces based on an identified context of each particular surface including at least one of surface size, surface position, real-world or virtual objects associated with the particular surface, or any combination thereof.

9. The method of claim 4,
wherein a layout specified for the identified surface defines how a plurality virtual containers added to the identified surface can be placed by defining slots on the identified surface; and
wherein the identified at least one virtual container, when added to the identified surface, is assigned one of the slots, causing a location of the identified at least one virtual container to be set according to a location of the assigned slot.

10. The method of claim 4,
wherein a layout specified for the identified surface defines how a plurality virtual containers, when added to the identified surface, can be placed by the layout defining slots on the identified surface;
wherein the identified at least one virtual container, when added to the identified surface, is assigned one of the slots, causing a location of the identified at least one virtual container to be set according to a location of the assigned slot; and
wherein the layout for the identified surface specifies one of:
a list layout wherein the plurality of virtual containers added to the identified surface are placed in a horizontal line spaced uniformly from each other;
a stack layout wherein the plurality of virtual containers added to the identified surface are placed in a vertical line spaced uniformly from each other; or
a grid layout wherein the plurality of virtual containers added to the identified surface are placed on a grid with a number of grid slots in each dimension of the identified surface, specified based on a number of the plurality of virtual containers added to the identified surface.

11. The method of claim 4,
wherein a layout specified for the identified surface defines how a plurality virtual containers, when added to the identified surface, can be placed by dynamically defining slots on the identified surface;
wherein the identified at least one virtual container, when added to the identified surface, is assigned one of the slots, causing a location of the identified at least one virtual container to be set according to a location of the assigned slot; and
wherein the layout for the identified surface specifies a freeform layout wherein the assigned slot is created on the identified surface, for the identified at least one virtual container, according to where the identified at least one virtual container was placed on the identified surface.

12. The method of claim 4,
wherein a layout specified for the identified surface defines how a plurality virtual containers, when added to the identified surface, can be placed by dynamically defining slots on the identified surface;
wherein the identified at least one virtual container, when added to the identified surface, is assigned one of the slots, causing a location of the identified at least one virtual container to be set according to a location of the assigned slot; and
wherein the layout for the identified surface is dynamic such that a number, size, and/or position of slots in the layout are specified in response to a number of the plurality of virtual containers, when added to the identified surface, a size of the plurality of virtual containers, when added to the identified surface, and/or where the plurality of virtual containers were initially placed on the identified surface.

13. The method of claim 4, wherein the identified surface is one or more of:
a surface positioned relative to an artificial reality system that controls the artificial reality environment;
a surface positioned relative to a real-world object detected by a machine learning recognizer trained to recognize one or more particular types of objects; or
a surface positioned relative to a real-world surface determined to have at least minimum geometric features.

14. The method of claim 4, wherein the identified at least one virtual container was associated with the identified surface in response to one of:
a user performing an interaction to add the identified at least one virtual container to the identified surface;
the identified at least one virtual container having been created with an association to the identified surface based on a particular virtual container, that caused creation of the identified at least one virtual container, being on the identified surface; or
execution of logic of the identified at least one virtual container or enablement of a display mode of the identified at least one virtual container, in response to the identified at least one virtual container having receiving context factors, that caused the identified at least one virtual container to be added to the identified surface.

15. A computing system for managing multiple virtual containers in an artificial reality environment, the computing system comprising:
one or more processors; and
one or more memories storing instructions that, when executed by the one or more processors, cause the computing system to perform a process comprising:
selecting, by at least one virtual container, a current display mode based at least in part on one or more properties of an identified surface,
wherein the one or more properties are received from an artificial reality environment controlling application that:
receives an identification of the surface in the artificial reality environment with at least a surface type property;
identifies the at least one virtual container, of the multiple virtual containers, that is associated with the identified surface; and
provides the one or more properties of the identified surface to the identified at least one virtual container; and
wherein the current display mode A) controls how the identified at least one virtual container writes content into a defined size or shape of an area or a volume that was set for the identified at least one virtual container in the current display mode and B) corresponds to the surface type property of the identified surface.

16. The computing system of claim 15,
wherein the specified properties include a surface type property of the identified surface that specifies an orientation of the identified surface; and
wherein the identified at least one virtual container evaluates one or more conditions to select the current display mode that corresponds to the orientation of the identified surface.

17. The computing system of claim 15, wherein the surface type property specifies types of virtual containers that can be added to the identified surface.

18. The computing system of claim 15,
wherein the one or more properties include a layout that defines how a plurality of virtual containers, when added to the identified surface, can be placed by defining slots on the identified surface; and
wherein the identified at least one virtual container, when added to the surface, is assigned one of the slots, causing a location of the identified at least one virtual container to be set according to a location of the assigned slot.

19. The computing system of claim 15,
wherein the one or more properties include a layout that defines how a plurality of virtual containers, when added to the identified surface, can be placed by dynamically defining slots on the identified surface;
wherein the identified at least one virtual container, when added to the identified surface, is assigned one of the slots, causing a location of the identified at least one virtual container to be set according to a location of the assigned slot; and
wherein the layout for the identified surface specifies a freeform layout wherein the slot is created on the identified surface, for the identified at least one virtual container, according to where the identified at least one virtual container was placed on the identified surface.

20. The computing system of claim 15,
wherein the one or more properties include a layout that defines how a plurality of virtual containers, when added to the identified surface, can be placed by dynamically defining slots on the identified surface;
wherein the identified at least one virtual container, when added to the identified surface, is assigned one of the slots, causing a location of the identified at least one virtual container to be set according to a location of the assigned slot; and
wherein the layout for the identified surface is dynamic such that a number, size, and/or position of slots in the layout are specified in response to a number of the plurality of virtual containers, when added to the identified surface, a size of the plurality of virtual containers, when added to the identified surface, and/or where the plurality of virtual containers were initially placed on the identified surface.

21. The computing system of claim 15, wherein the identified surface is one or more of:
a surface positioned relative to an artificial reality device that controls the artificial reality environment;
a surface positioned relative to a real-world object detected by a machine learning recognizer trained to recognize one or more particular types of objects; or
a surface positioned relative to a real-world surface determined to have at least a minimum set of geometric properties.

22. The computing system of claim 15, wherein the identified at least one virtual container was associated with the identified surface in response to one of:
a user performing an interaction to add the identified at least one virtual container to the identified surface; or
the identified at least one virtual container having been created with an association to the identified surface based on a particular virtual container, that caused creation of the identified at least one virtual container, being on the identified surface.

20. A non-transitory computer-readable storage medium storing instructions that, when executed by a computing system, cause the computing system to perform a process for managing virtual containers, the process comprising:
receiving an identification of a surface in the artificial reality environment with at least a surface type property;
identifying at least one virtual container, of multiple virtual containers, that is associated with the identified surface; and
providing one or more properties of the identified surface to the identified at least one virtual container;
wherein the identified at least one virtual container selects a current display mode based at least in part on the one or more properties of the identified surface, and
wherein the current display mode A) controls how the identified at least one virtual container writes content into a defined size or shape of an area or a volume that was set for the identified at least one virtual container in the current display mode and B) corresponds to the surface type property of the identified surface.
